(19) United States
(12) Patent Application Publication
(10) Pub. No.: US 2022/0287914 A1
(43) Pub. Date: Sep. 15, 2022

(54) Cone-Shaped Bottle Insert

(71) Applicant: Carol L. Ovans, Calgary (CA)

(72) Inventor: Carol L. Ovans, Calgary (CA)

(21) Appl. No.: 17/690,649

(22) Filed: Mar. 9, 2022

(30) Foreign Application Priority Data
Mar. 10, 2021 (CA) 3111369

(51) Int. Cl. A61J 1/20

(52) U.S. Cl. CPC A61J 1/2096; A61J 1/2048

(57) ABSTRACT

It can be very difficult to extract all of the liquid medication from a bottle with a flat top, using a hypodermic syringe with a needle for giving vaccinations as the liquid remains flat and even. The interior of the cone-shaped bottle insert is cone-shaped to allow the liquid to flow downward into the smaller pointed end, reducing the surface area of the liquid. This allows for the liquid to be fully and easily extracted. The cone-shaped bottle insert will eliminate the current and wasteful problem of not being able to extract all of the liquid from the bottle. The cone-shaped bottle insert can also be used for extracting liquid oral medications, using an oral syringe, without a needle, by adding a hole at the smaller pointed end.

### TECHNICAL FIELD

The invention relates to a cone-shaped bottle insert for a more efficient extraction of liquid medications using a hypodermic syringe with a needle, for use in vaccinations.

### BACKGROUND

With the current flat top, it is very difficult to extract the last remaining liquid contents of a bottle using a hypodermic syringe, with a needle, as the liquid remains flat and even.

### SUMMARY

The interior of the cone-shaped bottle insert is cone-shaped to allow the liquid to flow downward into the smaller pointed end. This allows for the liquid to be fully and easily extracted, eliminating the wasteful practice of not being able to empty the bottle.

The cone-shaped bottle insert can also be used for extracting liquid oral medication using an oral syringe without a needle.

### BRIEF DESCRIPTION OF THE DRAWINGS

In the drawing which illustrates the embodiment of the invention:

FIG. 1 shows a cross-sectional view of a bottle with a cone-shaped bottle insert in position for extracting liquid.

### DETAILED DESCRIPTION

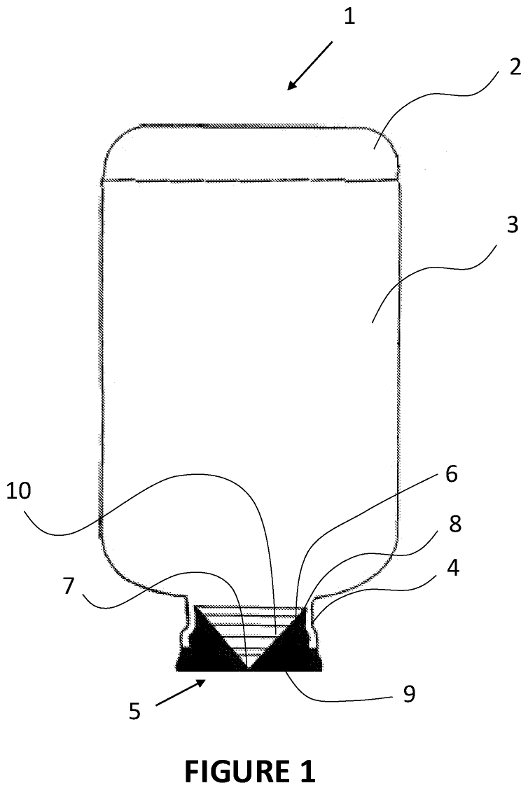

FIG. 1 shows a bottle 1 in position for extracting liquid with a hypodermic syringe with a needle having an airspace 2 at the top, liquid contents 3 in the bottle 3, a bottle neck 4 and the cone-shaped bottle insert 5. The cone-shaped bottle insert 5 has a first end 8, a second end 9, and an opening with a wide end 6 and a pointed end 7 that forms the cone shape. In the illustrated embodiment, the cone shaped interior surface 10 tapers smoothly from the wide end 6 to the pointed end 7.

Description of the Best Way of Using the Cone-Shaped Bottle Insert

The cone-shaped bottle insert 5 fits into the neck 4 of a bottle. When the bottle is in position for extracting liquid (upside down) the liquid flows downward into the cone-shaped insert. This allows for a more fully and easier extraction of liquid medications using a hypodermic syringe, with a needle for use in vaccinations.

The cone-shaped bottle insert can also be used for extracting liquid oral medications, using an oral syringe without a needle, by adding a hole at the smaller pointed end 7.

The cone-shaped bottle insert would also be useful for extracting any liquid solution or product using a hypodermic syringe with a needle, for use in giving injections.

The cone-shaped bottle insert can be used with the current metal ring seal and cap, using bottles that require extraction of the liquid with a hypodermic syringe and needle.

The cone-shaped bottle insert could also be used with liquid solution bags containing fluids for intravenous or injection use that require a hypodermic syringe and needle to extract the fluid.

1. A cone-shaped bottle insert to allow for more efficient and easy extraction of liquid medication from a bottle using a hypodermic syringe with a needle or an oral syringe comprising:
an insert sized and shaped to fit into a neck of the bottle and comprising a cone-shaped interior surface forming an opening having a wide end adjacent a first end of the insert, and a pointed end adjacent a second end of the insert, wherein upon insertion of the insert into the bottle neck, the wide end faces an interior of the bottle, causing any liquid medication in the bottle to gather in the pointed end of the opening when the bottle is upside down.

2. The cone-shaped bottle insert of claim 1, wherein the cone-shaped interior surface tapers smoothly from the wide end to the pointed end.

3. The cone-shaped bottle insert of claim 1, wherein an outer surface of the first end of the insert is pointed.

4. The cone-shaped bottle insert of claim 1, wherein the insert further comprises a hole between the pointed end of the opening and the second end for receiving the oral syringe.

5. The cone-shaped bottle insert of claim 2, wherein an outer surface of the first end of the insert is pointed.

6. An assembly to allow for more efficient and easy extraction of liquid medication using a hypodermic syringe with a needle or an oral syringe comprising:
a bottle having a neck and a body; and
a cone-shaped bottle insert in the bottle neck comprising a cone-shaped interior surface forming an opening having a wide end and a pointed end, the wide end adjacent a first end of the insert that faces an interior of the bottle, and the pointed end adjacent a second end of the insert such that any liquid medication in the bottle gathers in the pointed end of the opening when the bottle is upside down.

7. The assembly of claim 6, wherein an outer wall of the insert is substantially aligned with an inner wall of the bottle neck.

8. The assembly of claim 6, wherein the cone-shaped interior surface tapers smoothly from the wide end to the pointed end.

9. The assembly of claim 6, wherein an outer end surface of the first end of the insert is pointed.

10. The assembly of claim 6, wherein the insert further comprises a hole between the pointed end of the opening and the second end for receiving the oral syringe.

11. The assembly of claim 6, wherein the cone-shaped interior surface tapers smoothly from the wide end to the pointed end, and an outer end surface of the first end of the insert is pointed.
